(19) United States
(12) Patent Application Publication
(10) Pub. No.: US 2013/0041729 A1
(43) Pub. Date: Feb. 14, 2013

(54) SYSTEM AND METHOD TO FACILITATE RETAIL PROMOTIONS

(71) Applicants: Daniel Jeffrey Shader, Palo Alto, CA (US); Kurt Thams, Santa Cruz, CA (US); Richard Scott Perkins, Meridian, ID (US); John Paul Minor, Brick, NJ (US)

(72) Inventors: Daniel Jeffrey Shader, Palo Alto, CA (US); Kurt Thams, Santa Cruz, CA (US); Richard Scott Perkins, Meridian, ID (US); John Paul Minor, Brick, NJ (US)

(21) Appl. No.: 13/209,291

(22) Filed: Aug. 12, 2011

(51) Int. Cl. G06Q 30/02

(52) U.S. Cl. 705/14.4

(57) ABSTRACT

Disclosed herein are systems and methods for facilitating retail promotions. The systems and methods disclosed generally include: (a) defining terms of a retail promotion; (b) identifying whether a consumer has acted in accordance with the terms of the retail promotion; and (c) authorizing a tender presented by the consumer, based on whether the consumer has acted in accordance with the terms of the retail promotion. The disclosed systems and methods have wide ranging applicability, including (non-exclusively): (1) allowing a brand company to initiate localized promotions at a point-of-sale retailer; (2) allowing a point-of-sale retailer to initiate localized promotions; and/or (3) allowing a point-of-sale retailer to build a customer database and build customer loyalty, without having to make significant changes to their point-of-sale terminal infrastructure.

### SUMMARY

Disclosed herein are systems and methods for facilitating retail promotions by providing a consumer with a form of tender whose value changes depending on the contents of the consumer's basket of goods at a point-of-sale retailer. The systems and methods disclosed generally include: (a) defining terms of a retail promotion; (b) identifying whether a consumer has acted in accordance with the terms of the retail promotion; and (c) authorizing a tender presented by the consumer, based on whether the consumer has acted in accordance with the terms of the retail promotion. The disclosed systems and methods have wide ranging applicability, including (non-exclusively): (1) allowing a brand company to initiate localized promotions at a point-of-sale retailer; (2) allowing a point-of-sale retailer to initiate localized promotions; and/or (3) allowing a point-of-sale retailer to build a customer database and build customer loyalty, without having to make significant changes to their point-of-sale terminal infrastructure.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level flow chart illustrating processes and relationships previously available to the parties that partake in the presented systems and methods.

FIG. 2 is a high-level flow chart illustrating aspects of the presented systems and methods.

FIG. 3 is a high-level flowchart illustrating a method for facilitating retail promotions, in accordance with one embodiment presented herein.

FIG. 4 is a schematic drawing of a computer system used to implement the methods presented herein.

### DETAILED DESCRIPTION

Disclosed herein are systems and methods for facilitating retail promotions. The systems and methods disclosed are generally performed by a service provider for the benefit of at least one point-of-sale (POS) retailer (e.g., a retail store or retail chain). In essence, the service provider is serving as a cloud-based computing solution to the POS retailer. By receiving “the contents of the basket” (as will be further described below) and controlling the tender at the POS terminal (i.e., the register), the service provider can replicate and/or augment the function of the POS terminal while adding additional features, functions, and processes that would not otherwise be available at the POS terminal.

For example, in one embodiment, the service provider generally: (a) defines, sets, receives, or otherwise establishes terms of a retail promotion; (b) receives data on a consumer's actions at the POS terminal; (c) identifies whether the consumer has acted in accordance with the terms of the retail promotion; and (d) authorizes a tender presented by the consumer, based on whether the consumer has acted in accordance with the terms of the retail promotion. The disclosed systems and methods have wide ranging applicability, including (non-exclusively): (1) allowing a brand company to initiate localized promotions at a point-of-sale retailer; (2) allowing a point-of-sale retailer to initiate localized promotions; and/or (3) allowing a point-of-sale retailer to build a customer database and build customer loyalty, without having to make significant changes to their point-of-sale terminal infrastructure.

In one embodiment, the systems and methods further include: (e) effectuating the tender based on the consumer's actions; and/or (f) changing a value of the tender based on the consumer's action. For example, the data on the consumer's action (described herein as “the contents of the basket”) may include promotional considerations and/or variables such as: a stock-keeping unit (SKU) identifier of items purchased or presented, a mix of items purchased or presented, quantities of items purchased or presented, time of day, date, location of POS retailer, customer identifier, amounts paid, and any equivalents or combinations thereof. Examples of equivalent promotions and promotional considerations include: the weather (e.g., “50% of soda purchases when the temperature exceeds 90 degrees”); sporting event results (e.g., “50% of soda purchases when the home team wins”); or other events (e.g., “50% of soda purchases when the downtown parade ends”). Before or during the consumer's visit to the POS retailer, the consumer may be provided a form of tender such as: a print-out voucher, a quick response (QR) code, a barcode, a prepaid card, an alphanumeric code, a pin number, and any combinations or equivalents thereof. As such, if the consumer's action match the pre-defined terms of the retail promotion (e.g., purchase of a defined mix of items on a specific date), then the form of tender is authorized, validated, effectuated, or otherwise accepted as a form of payment at the POS terminal.

In one or more other embodiments, the systems and methods further include: (g) providing a notification to the consumer at the POS terminal; (h) providing the consumer with the one or more terms of the retail promotion; (i) receiving consumer registration information from the consumer; and/or (j) populating a consumer database based on the consumer registration information.

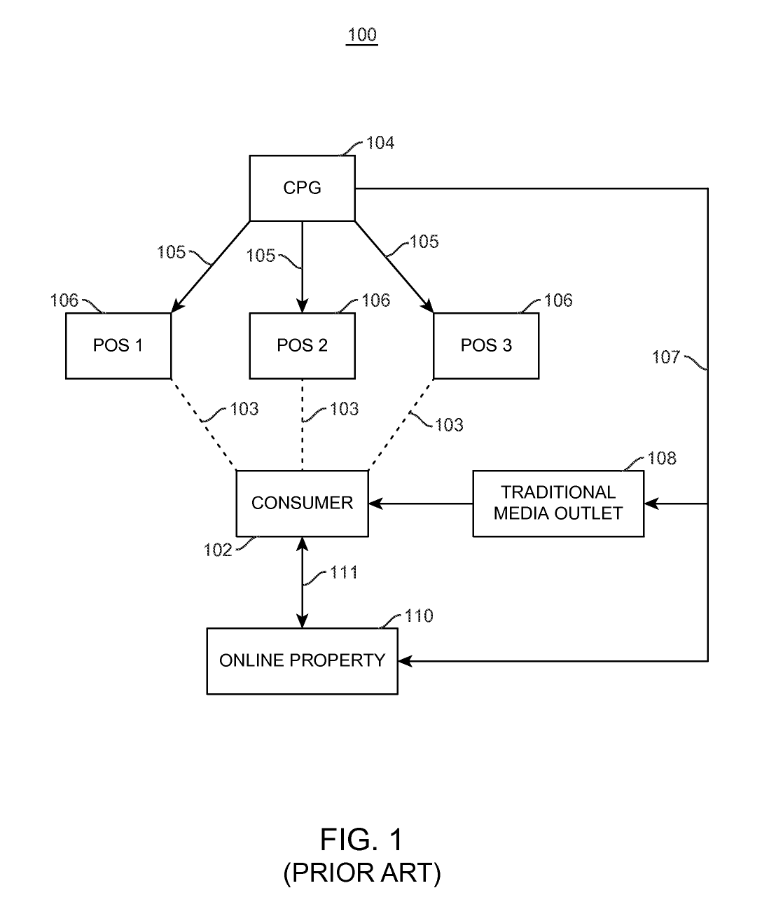

The following is a description of one or more embodiments of the present invention, with reference to FIGS. 1-4. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

FIG. 1 is a high-level flow chart illustrating processes and relationships previously available to the parties that partake in the presented systems and methods. In a typical off-line retail environment 100, a consumer 102 visits (dotted line 103) one or more POS retailers 106, in order to purchase goods 105 provided by a brand company, such as consumer-packaged goods (CPG) company 104. In order to increase consumer visits to POS retailers 106, CPG 104 may spend marketing funds (arrow 107) on a traditional media outlet 108 (e.g., television, newspaper, magazine, etc.), an online property 110 (e.g., a website, social network, Facebook™, Twitter™, mobile app, etc.), through traditional coupons (not shown), or other alternative means. Consumer 102 may in turn have an information-rich relationship 111 with online property 110, wherein the consumer's identification data is kept on a database controlled by online property 110. However, unfortunately for POS retailers 106, there's a growing trend wherein consumers 102 are showing a lack of loyalty to any particular POS retailer. In other words, there is a blurring of distribution channels, in which consumers 102 find CPG products 105 in one of many POS retailers 106, and have no affinity to any particular POS retailer. Further, POS retailers 106 lack the means to develop the information-rich relationships with consumers, such as relationships 111 between consumers 102 and online properties 110. Additionally, because POS retailers 106 cannot validate/prove visits 103 resulting from promotional campaigns, CPG 104 typically directs marketing funds 107 to traditional media outlets 108 and online properties 110, instead of directing such funds directly to POS retailers 106.

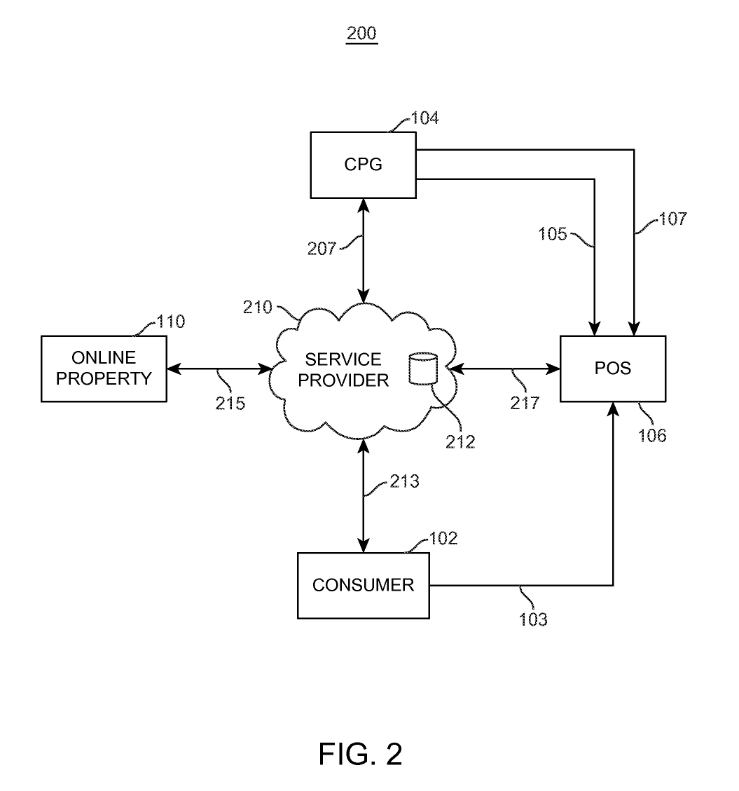

FIG. 2 is a high-level flow chart illustrating aspects of the presented systems and methods. As shown in FIG. 2, a service provider 210 serves as a cloud-based computing solution for POS retailer 106. In one embodiment, each party serves a stand-alone function within system 200. However, in an alternative embodiment, service provider 102 may be incorporated into, or be a functional unit of, CPG 104 and/or POS retailer 106.

In practice, POS retailer 106 uses interface 217 to send the contents of the consumer's basket to service provider 210, and allow service provider 210 to control the tender of payment between consumer 102 and the POS terminal. The contents of the basket includes information such as (non-exclusively): SKU identifier of items purchased or presented to the POS terminal, a mix of items purchased or presented, quantities of items purchased or presented, time of day, date, location of POS retailer, customer identifier, amounts paid, and any equivalents or combinations thereof, as well as any other promotional variables set or defined by any of the parties involved. By sending the contents of the basket up to service provider 102, the service provider can confirm whether the consumer is acting in accordance with a pre-defined promotion (i.e., whether the contents of the basket satisfy the terms of the promotion).

Service provider 210 then controls the tender of payment between consumer 102 and POS 106. As such, service provider 210 can effectuate and/or change the value of the tender depending on the contents of the basket. If the contents of the consumer's basket match the pre-defined terms of the retail promotion (e.g., the mix of items purchased on a specific date), then the form and/or value of tender may be authorized, validated, effectuated, changed, or otherwise accepted as a form of payment at the POS terminal. Forms of tender may include (non-exclusively): a print-out voucher, a QR code, a barcode, a prepaid card, an alphanumeric code, a pin number, and any combinations or equivalents thereof.

CPG 104 uses interface 207 to create, transmit, or otherwise define a desired retail promotion with service provider 210. In alternative embodiments, a retail promotion may be created, transmitted, or otherwise defined by service provider 210, online property 110, POS retailer 106, an unrelated party, and/or any combination thereof. Service provider 210 may then use various means to provide consumer 102 with notification of the promotion and/or a means of tender. For example, consumer 102 may register with service provider 210, wherein service provider 102 maintains a consumer database 212; consumer 102 may allow service provider 210 to retrieve the consumer's data 215 from an online property 110; and/or service provider 210 can provide a consumer 102 with notification at POS retailer 106. Because service provider 102 can use the data received over interface 217 to prove that a particular promotion is increasing visits 103 at POS retailer 106, and/or whether a certain promotion is generating positive consumer response at POS retailer 106, CPG 104 can redirect marketing funds 107 directly to POS retailer 106. Also, service provider 210 allows a means for POS retailer 106 to populate a consumer database 212, and thereby create programs to foster consumer loyalty at POS retailer 106. More generally, however, system 200 makes it possible for consumer data, which may be controlled by online property 110, CPG 104, POS retailer 106, or other third-party, to migrate amongst all parties involved if the proper agreements are in place between the parties.

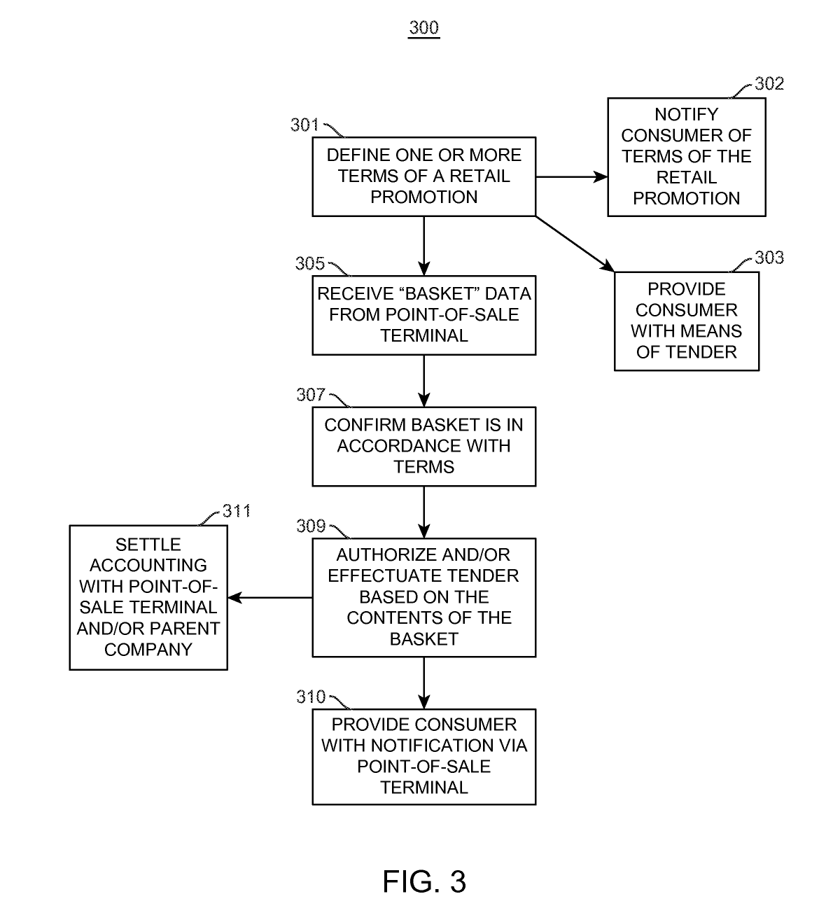

FIG. 3 is a high-level flowchart illustrating a method for facilitating retail promotions, in accordance with one embodiment presented herein. In step 301, one or more terms of a retail promotion are defined. As used herein, to “define” one or more terms may include setting rules based on direction and/or input from one or more third parties. As such, a service provider may define terms of a retail promotion under the direction or request of a brand company (e.g., CPG), a POS retailer, an online property, an unrelated party, and/or any combination thereof. In one example, to define terms of a retail promotion may include rules such as: if a consumer purchases items A and B, on date XX/XX/XXX, then the consumer will receive a promotional value of $Y. As used herein, to “purchase” an item generally includes, inter alia, presenting an item for purchase, showing intent to purchase, and/or offering to purchase. In steps 302 and 303, respectively, the service provider may notify consumers of the terms of the retail promotion and provide consumers with a means of tender. In alternative embodiments, a notification and/or form of tender may be provided by a CPG, an online property, a POS retailer, an unrelated party, and/or any combination thereof.

In step 305, the service provider receives the contents of the basket from the POS terminal. In other words, when a consumer visits a POS retailer/terminal, and presents goods for purchase, such presentment data is pushed, pulled, or otherwise sent to or receive by the service provider. In one embodiment, such “push” or “pull” function may be performed by a computerized application programming interface (API). (The terms “push,” “pull,” “send,” and/or “receive,” as used in this description, are not intended to be limiting.) Step 305 may be performed with or without knowledge or consent by the consumer. As such, the service provider may receive the contents of the basket in all circumstances. In step 307, the contents of the basket are checked against the terms of any and all existing or future retail promotions. In other words, the service provider confirms whether the basket is in accordance with the terms of the promotion, or establishes a new promotion in response to the consumer's actions.

If the contents of the basket are in accordance with the terms of the promotion, the service provider authorizes, validates, or otherwise effectuates tender, in step 309. The service provider may also change the value of the tender depending on the contents of the basket. In step 311, the service provider may settle accounting with the POS retailer and/or a parent company, with the POS terminal being completely blind to the value of the tender and/or promotion.

For example, a consumer may be notified of a CPG promotion to purchase two six-packs of soda (a value of $5.98) for the price of one ($2.99), but only after 3:00 PM on Wednesday afternoons (step 302). The consumer may also be provided with a means of tender, such as a QR code on their mobile device (step 303). If the consumer presents to the POS terminal two six-packs of soda after 3:00 PM on a Wednesday afternoon, such information is sent to the service provider. The service provider then confirms that the consumer has acted in accordance with the terms of the CPG promotion, and effectuates the tender by assigning a value of $5.98 to the tender (i.e., the QR code). The QR code can be read at the POS terminal, and the POS terminal can interpret the QR code as having paid the full value of $5.98. The consumer would then pay $2.99, either directly to the service provider, or to the POS terminal. The balance of the value of the promotion can be supplied as a marketing fund from the CPG.

In step 310, the consumer may be provided with a notification via the POS terminal. For example, the service provider may take control of the receipt printing operation and provide various notifications and instructions to the consumer. In one example, the service provider can use the notification process to invite/require the consumer to register their personal identification information with the service provider, in a database, in order to receive future promotional information. In another example, the service provider may receive the contents of the basket (regardless of whether the consumer knows of an existing promotion or presents a unique tender) and cause a notification to be printed on the receipt if a particular product is purchased. As such, the service provider can execute a promotion in all circumstances, even when no particular tender has been presented.

### Computer Implementation.

The presented methods, or any part(s) or function(s) thereof, may be implemented using hardware, software, or a combination thereof, and may be implemented in one or more computer systems or other processing systems. For example, the presented methods may be implemented with the use of one or more dedicated servers and/or cloud-based architecture. Where the presented methods refer to manipulations that are commonly associated with mental operations, such as, for example, receiving, selecting, identifying, confirming, authorizing, and the like, no such capability of a human operator is necessary. In other words, any and all of the operations described herein may be machine operations. Useful machines for performing the operation of the methods include general and/or special purpose digital computers, hand-held mobile device or smartphones, computer systems programmed to perform the specialized algorithms described herein, or similar devices.

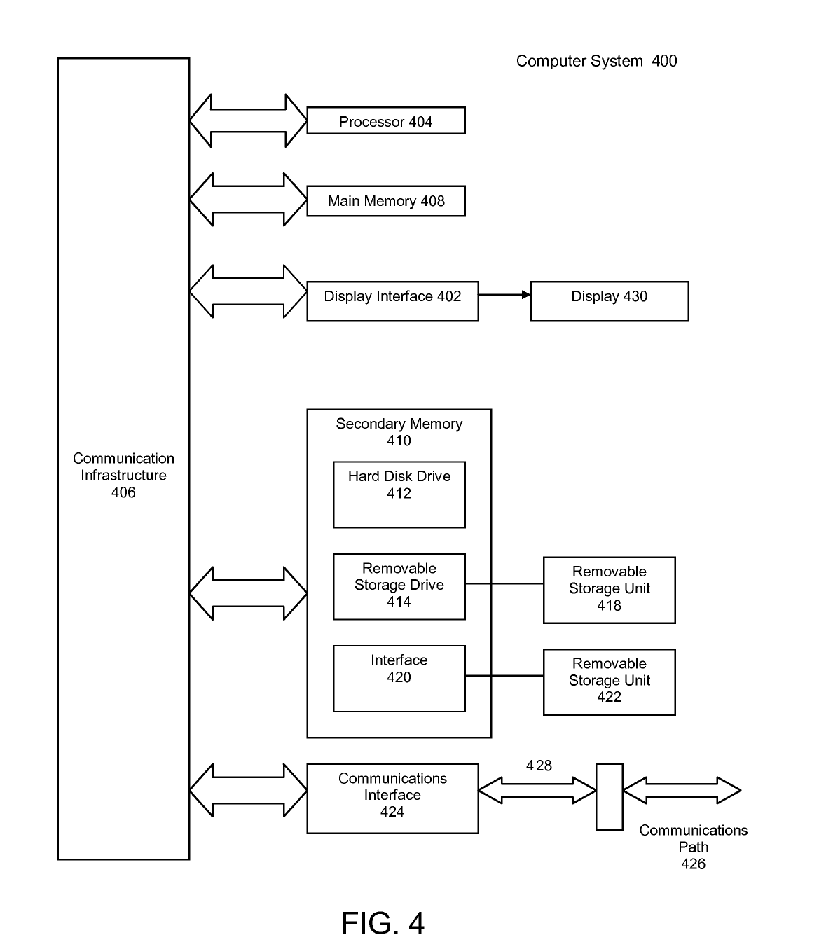

In one embodiment, the invention is directed toward one or more computer systems capable of carrying out the functionality described herein. For example, FIG. 4 is a schematic drawing of a computer system 400 used to implement the methods presented above. Computer system 400 includes one or more processors, such as processor 404. The processor 404 is connected to a communication infrastructure 406 (e.g., a communications bus, cross-over bar, or network). Computer system 400 can include a display interface 402 that forwards graphics, text, and other data from the communication infrastructure 406 (or from a frame buffer not shown) for display on a local or remote display unit 430.

Computer system 400 also includes a main memory 408, such as random access memory (RAM), and may also include a secondary memory 410. The secondary memory 410 may include, for example, a hard disk drive 412 and/or a removable storage drive 414, representing a floppy disk drive, a magnetic tape drive, an optical disk drive, flash memory device, etc. The removable storage drive 414 reads from and/or writes to a removable storage unit 418. Removable storage unit 418 represents a floppy disk, magnetic tape, optical disk, flash memory device, etc., which is read by and written to by removable storage drive 414. As will be appreciated, the removable storage unit 418 includes a computer usable storage medium having stored therein computer software, instructions, and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow computer software, instructions, and/or data to be transferred from the removable storage unit 422 to computer system 400.

Computer system 400 may also include a communications interface 424. Communications interface 424 allows computer software, instructions, and/or data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 414, removable storage units 418, 422, data transmitted via communications interface 424, and/or a hard disk installed in hard disk drive 412. These computer program products provide computer software, instructions, and/or data to computer system 400. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the presented methods. Accordingly, such computer programs represent controllers of the computer system 400. Where appropriate, the processor 404, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 400 using removable storage drive 414, interface 420, hard drive 412, or communications interface 424. The control logic (software), when executed by the processor 404, causes the processor 404 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) define one or more terms of a retail promotion; (b) identify whether a consumer has acted in accordance with the one or more terms of the retail promotion; and (c) authorize a tender presented by the consumer based on whether the consumer has acted in accordance with the one or more terms of the retail promotion. The computer-readable storage medium may further comprise instructions executable by at least one processing device that, when executed, cause the processing device to: (d) receive data on the consumer's action; (e) effectuate the tender; (f) change a value of the tender based on the consumer's action; (g) provide a notification to the consumer; and/or (h) provide the consumer with the one or more terms of the retail promotion. The computer-readable storage medium may further comprise instructions executable by at least one processing device that, when executed, cause the processing device to: (i) receive consumer registration information from the consumer; (j) populate a consumer database based on the consumer registration information; and/or (k) provide the consumer with the tender. The data on the consumer's action may include promotion variables selected from the group consisting of: SKU identifier of items purchased or presented, mix of items purchased or presented, quantities of items purchased or presented, time of day, date, location, customer identifier, amounts paid, and any or equivalents combinations thereof (e.g., the weather, the results of a sporting event, or any other event). The form of tender may be selected from the group consisting of: a print-out voucher, a QR code, a barcode, a prepaid card, an alphanumeric code, a pin number, and any combinations or equivalents thereof.

In still another embodiment, there is provided a computer-based system having: (a) means for defining one or more terms of a retail promotion; (b) means for identifying whether a consumer has acted in accordance with the one or more terms of the retail promotion; and (c) means for authorizing a tender presented by the consumer based on whether the consumer has acted in accordance with the one or more terms of the retail promotion. The system may further include: (d) an interface for communicating data with a point-of-sale terminal. The interface may allow the system to receive data on the consumer's action and to effectuate the tender. The data on the consumer's action may include promotion variables selected from the group consisting of: SKU identifier of items purchased or presented, mix of items purchased or presented, quantities of items purchased or presented, time of day, date, location, customer identifier, amounts paid, and any combinations or equivalents thereof (e.g., the weather, the results of a sporting event, or any other event). The system may further include: (e) means for providing a notification to the consumer. The means for providing a notification may include providing the consumer with the one or more terms of the retail promotion. The system may further include: (f) means for receiving consumer registration information from the consumer; (g) means for populating a consumer database based on the consumer registration information; and/or (h) means for providing the consumer with the tender.

### CONCLUSION

It is noted that the figures, individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between CPG 104, online property 110, POS retailer 106, and/or service provider 210 are performed via an automated computer-based system, such as an application program interface. Further, not all of the individual process or sub-process described are necessary for implementing the systems and methods described herein. As such, the embodiments presented in the figures are not intended to be limiting.

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method for facilitating a promotion, comprising:
(a) defining one or more terms of a retail promotion;
(b) identifying whether a consumer has acted in accordance with the one or more terms of the retail promotion; and
(c) authorizing a tender presented by the consumer based on whether the consumer has acted in accordance with the one or more terms of the retail promotion.

2. The method of claim 1, further comprising:
receiving data on the consumer's action, and effectuating the tender.

3. The method of claim 2, further comprising:
changing a value of the tender based on the consumer's action.

4. The method of claim 2, wherein the data on the consumer's action includes promotion variables selected from the group consisting of: a SKU identifier of items purchased or presented, a mix of items purchased or presented, quantities of items purchased or presented, time of day, date, location, customer identifier, amounts paid, and any equivalents or combinations thereof.

5. The method of claim 1, further comprising:
providing a notification to the consumer at a point-of-sale terminal.

6. The method of claim 1, further comprising:
providing the consumer with the one or more terms of the retail promotion.

7. The method of claim 1, further comprising:
receiving consumer registration information from the consumer, and populating a consumer database based on the consumer registration information.

8. The method of claim 1, further comprising:
providing the consumer with the tender.

9. The method of claim 8, wherein the tender is in the form of: a print-out voucher, a QR code, a barcode, a prepaid card, an alphanumeric code, a pin number, and any combinations thereof.

10. A system for facilitating promotions, comprising:
means for defining one or more terms of a retail promotion;
means for identifying whether a consumer has acted in accordance with the one or more terms of the retail promotion; and
means for authorizing a tender presented by the consumer based on whether the consumer has acted in accordance with the one or more terms of the retail promotion.

11. The system of claim 10, further comprising:
an interface for communicating data with a point-of-sale terminal, wherein the interface allows the system to receive data on the consumer's action, and wherein the interface allows the system to effectuate the tender.

12. The system of claim 11, wherein the data on the consumer's action includes promotion variables selected from the group consisting of: a SKU identifier of items purchased or presented, a mix of items purchased or presented, quantities of items purchased or presented, time of day, date, location, customer identifier, amounts paid, and any equivalents or combinations thereof.

13. The system of claim 10, further comprising:
means for providing a notification to the consumer.

14. The system of claim 13, wherein said means for providing a notification include providing the consumer with the one or more terms of the retail promotion.

15. The system of claim 10, further comprising:
means for receiving consumer registration information from the consumer; and
means for populating a consumer database based on the consumer registration information.

16. The system of claim 10, further comprising:
means for providing the consumer with the tender.

17. A computer-readable storage medium, comprising:
instructions executable by at least one processing device that, when executed, cause the processing device to
(a) define one or more terms of a retail promotion;
(b) identify whether a consumer has acted in accordance with the one or more terms of the retail promotion; and
(c) authorize a tender presented by the consumer based on whether the consumer has acted in accordance with the one or more terms of the retail promotion.

18. The computer-readable storage medium of claim 17, further comprising:
instructions executable by at least one processing device that, when executed, cause the processing device to
receive data on the consumer's action, and
effectuate the tender.

19. The computer-readable storage medium of claim 18, further comprising:
instructions executable by at least one processing device that, when executed, cause the processing device to change a value of the tender based on the consumer's action.

20. The computer-readable storage medium of claim 18, wherein the data on the consumer's action includes promotion variables selected from the group consisting of: a SKU identifier of items purchased or presented, a mix of items purchased or presented, quantities of items purchased or presented, time of day, date, location, customer identifier, amounts paid, and any equivalents or combinations thereof.

21. The computer-readable storage medium of claim 17, further comprising:
instructions executable by at least one processing device that, when executed, cause the processing device to provide a notification to the consumer.

22. The computer-readable storage medium of claim 17, further comprising:
instructions executable by at least one processing device that, when executed, cause the processing device to provide the consumer with the one or more terms of the retail promotion.

23. The computer-readable storage medium, of claim 17, further comprising:
instructions executable by at least one processing device that, when executed, cause the processing device to
receive consumer registration information from the consumer, and
populate a consumer database based on the consumer registration information.

24. The computer-readable storage medium of claim 17, further comprising:
instructions executable by at least one processing device that, when executed, cause the processing device to provide the consumer with the tender.
